(19) United States
(12) Patent Application Publication
(10) Pub. No.: US 2026/0025055 A1
(43) Pub. Date: Jan. 22, 2026

(54) ELECTRIC POWER CONVERSION APPARATUS

(71) Applicant: TDK CORPORATION, Tokyo (JP)

(72) Inventors: Takamichi SUGAWARA, Tokyo (JP); Kenji NEGORO, Tokyo (JP)

(73) Assignee: TDK CORPORATION, Tokyo (JP)

(21) Appl. No.: 19/270,113

(22) Filed: Jul. 15, 2025

(30) Foreign Application Priority Data
Jul. 19, 2024 (JP) 2024-116279

(51) Int. Cl. H02M 1/00; H02M 1/088; H02M 5/12; H02M 7/217; H02M 7/5387

(52) U.S. Cl. CPC H02M 1/007; H02M 1/088; H02M 5/12; H02M 7/217; H02M 7/5387

(57) ABSTRACT

An electric power conversion apparatus includes: an input power terminal; a switching circuit; a first driving circuit configured to perform a first driving operation of driving the switching circuit, and configured to stop the first driving operation, based on a first driving control signal; a transformer including first and second windings; a rectifying circuit configured to rectify a signal supplied from the second winding and including a first rectification switching device turning on and off based on a first driving signal; a second driving circuit configured to perform a second driving operation that includes driving the first rectification switching device through the first driving signal, and configured to stop the second driving operation based on a second driving control signal; a signal generation circuit configured to generate the first driving control signal, based on a control signal and the first driving signal; a smoothing circuit; and an output power terminal.

### CROSS-REFERENCE TO RELATED APPLICATIONS

The present application claims priority from Japanese Patent Application No. 2024-116279 filed on Jul. 19, 2024, the entire contents of which are hereby incorporated by reference.

### BACKGROUND

The disclosure relates to an electric power conversion apparatus that converts electric power.

Some of electric power conversion apparatuses are provided with a switching circuit on a primary side of a transformer, and a rectifying circuit on a secondary side of the transformer. The switching circuit and the rectifying circuit each include a switching device. For example, Japanese Unexamined Patent Application Publication (JP-A) No. 2004-215356 discloses a technique in which, to stop operation of an electric power conversion apparatus, a switching device of a rectifying circuit on a secondary side is first caused to stop operating and thereafter a switching device of a switching circuit on a primary side is caused to stop operating.

### SUMMARY

An electric power conversion apparatus according to one embodiment of the disclosure includes an input electric power terminal, a switching circuit, a first driving circuit, a transformer, a rectifying circuit, a second driving circuit, a signal generation circuit, a smoothing circuit, and an output electric power terminal. The switching circuit is coupled to the input electric power terminal and is configured to perform a switching operation. The first driving circuit is configured to perform a first driving operation of driving the switching circuit, and configured to stop the first driving operation, based on a first driving control signal. The transformer includes a first winding and a second winding. The first winding is led to the switching circuit. The rectifying circuit includes a first rectification switching device coupled to the second winding and configured to be turned on and off based on a first driving signal. The rectifying circuit is configured to rectify a signal supplied from the second winding, by performing a switching operation. The second driving circuit is configured to generate the first driving signal, configured to perform a second driving operation that includes driving the first rectification switching device through the first driving signal, and configured to stop the second driving operation, based on a second driving control signal corresponding to a control signal. The signal generation circuit is configured to generate the first driving control signal, based on the control signal and the first driving signal. The smoothing circuit is configured to smooth a voltage rectified by the rectifying circuit. The output electric power terminal is coupled to the smoothing circuit.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a circuit diagram illustrating a configuration example of an electric power conversion apparatus according to one example embodiment of the disclosure.

FIG. 2 is a circuit diagram illustrating a configuration example of a signal generation circuit illustrated in FIG. 1.

FIG. 3 is a timing waveform diagram illustrating an operation example of the electric power conversion apparatus illustrated in FIG. 1.

FIG. 4A is an explanatory diagram illustrating an operation state of the electric power conversion apparatus illustrated in FIG. 1.

FIG. 4B is an explanatory diagram illustrating another operation state of the electric power conversion apparatus illustrated in FIG. 1.

FIG. 5 is a timing waveform diagram illustrating an example of an operation of starting a switching operation in the electric power conversion apparatus illustrated in FIG. 1.

FIG. 6 is a timing waveform diagram illustrating an example of an operation of stopping the switching operation in the electric power conversion apparatus illustrated in FIG. 1.

FIG. 7 is a circuit diagram illustrating a configuration example of a signal generation circuit according to a modification example.

FIG. 8 is a circuit diagram illustrating a configuration example of an electric power conversion apparatus according to another modification example.

FIG. 9 is a circuit diagram illustrating a configuration example of a signal generation circuit illustrated in FIG. 8.

FIG. 10 is a timing waveform diagram illustrating an example of the operation of stopping the switching operation in the electric power conversion apparatus illustrated in FIG. 8.

### DETAILED DESCRIPTION

What is desired of an electric power conversion apparatus is that a switching operation of primary-side circuitry be stopped after a switching operation of secondary-side circuitry is stopped. Achieving increased robustness of such an operation of stopping the switching operations is expected of the electric power conversion apparatus.

It is desirable to provide an electric power conversion apparatus that makes it possible to achieve increased robustness of an operation of stopping a switching operation.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings. Note that the description is given in the following order.

### Configuration Example

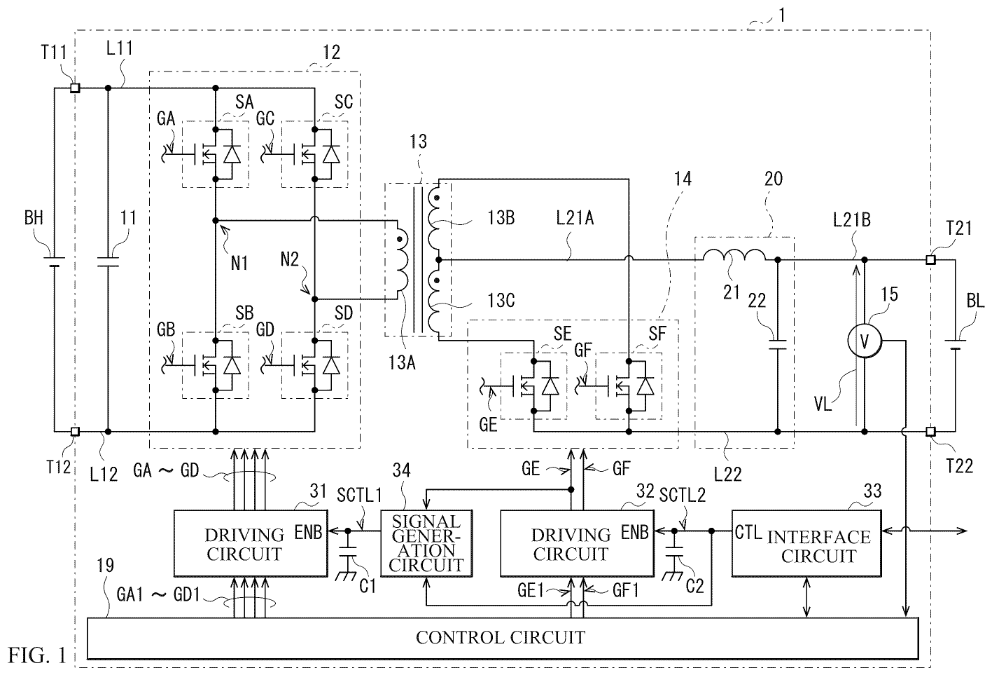

FIG. 1 illustrates a configuration example of an electric power conversion apparatus 1 according to an example embodiment of the disclosure. The electric power conversion apparatus 1 may include input electric power terminals T11 and T12 and output electric power terminals T21 and T22. The input electric power terminals T11 and T12 may be coupled to a high voltage battery BH, and the output electric power terminals T21 and T22 may be coupled to a low voltage battery BL. The high voltage battery BH may have a voltage of, for example, 400 V, and the low voltage battery BL may have a voltage of, for example, 12 V. The electric power conversion apparatus 1 may be configured to convert electric power by stepping down a voltage supplied from the high voltage battery BH, and to supply the converted electric power to the low voltage battery BL.

The electric power conversion apparatus 1 may include a capacitor 11, a switching circuit 12, a transformer 13, a rectifying circuit 14, a smoothing circuit 20, a voltage sensor 15, a control circuit 19, driving circuits 31 and 32, capacitors C1 and C2, an interface circuit 33, and a signal generation circuit 34. Primary-side circuitry of the electric power conversion apparatus 1 may include the high voltage battery BH, the capacitor 11, and the switching circuit 12. Secondary-side circuitry of the electric power conversion apparatus 1 may include the rectifying circuit 14, the smoothing circuit 20, the voltage sensor 15, and the low voltage battery BL. In the electric power conversion apparatus 1, the input electric power terminal T11 may be coupled to a voltage line L11, and the input electric power terminal T12 may be coupled to a reference voltage line L12. The output electric power terminal T21 may be coupled to a voltage line L21B, and the output electric power terminal T22 may be coupled to a reference voltage line L22.

The capacitor 11 may have a first end coupled to the voltage line L11, and a second end coupled to the reference voltage line L12.

The switching circuit 12 may be configured to convert a direct-current voltage supplied from the high voltage battery BH into an alternating-current voltage, by performing a switching operation. The switching circuit 12 may be a full-bridge circuit, and may include transistors SA, SB, SC, and SD. The transistors SA to SD may be switching devices that perform switching operations, respectively based on driving signals GA to GD. The transistors SA to SD may each include an N-type field-effect transistor (FET), for example. The transistors SA to SD may each include a body diode. For example, the body diode of the transistor SA may include an anode coupled to a source of a body of the transistor SA, and a cathode coupled to a drain of the body of the transistor SA. This similarly applies to the transistors SB to SD. Although the N-type field-effect transistor may be used in this example embodiment, this is non-limiting, and any kind of switching device may be used.

The transistor SA may be provided in a path coupling the voltage line L11 and a node N1 to each other, and may be configured to couple the node N1 to the voltage line L1 when turned on. The drain of the transistor SA may be coupled to the voltage line L11, a gate of the transistor SA may receive the driving signal GA, and the source of the transistor SA may be coupled to the node N1. The transistor SB may be provided in a path coupling the node N1 and the reference voltage line L12 to each other, and may be configured to couple the node N1 to the reference voltage line L12 when turned on. The drain of the transistor SB may be coupled to the node N1, a gate of the transistor SB may receive the driving signal GB, and the source of the transistor SB may be coupled to the reference voltage line L12.

The transistor SC may be provided in a path coupling the voltage line L11 and a node N2 to each other, and may be configured to couple the node N2 to the voltage line L11 when turned on. The drain of the transistor SC may be coupled to the voltage line L11, a gate of the transistor SC may receive the driving signal GC, and the source of the transistor SC may be coupled to the node N2. The transistor SD may be provided in a path coupling the node N2 and the reference voltage line L12 to each other, and may be configured to couple the node N2 to the reference voltage line L12 when turned on. The drain of the transistor SD may be coupled to the node N2, a gate of the transistor SD may receive the driving signal GD, and the source of the transistor SD may be coupled to the reference voltage line L12.

The transformer 13 may be configured to provide direct-current isolation and alternating-current coupling between the primary-side circuitry and the secondary-side circuitry, and configured to convert an alternating-current voltage supplied from the primary-side circuitry with a transformation ratio of the transformer 13 and supply the converted alternating-current voltage to the secondary-side circuitry. The transformer 13 may include windings 13A, 13B and 13C. The winding 13A may be a primary winding. The winding 13A may have a first end coupled to the node N1 in the switching circuit 12, and a second end coupled to the node N2 in the switching circuit 12. The windings 13B and 13C may be secondary windings. The winding 13B may have a first end coupled to a drain of a transistor SF of the rectifying circuit 14, and a second end coupled to a voltage line L21A. The winding 13C may have a first end coupled to the voltage line L21A, and a second end coupled to a drain of a transistor SE of the rectifying circuit 14. The transistors SE and SF will be described later.

The rectifying circuit 14 may be configured to rectify an alternating-current voltage outputted from the windings 13B and 13C of the transformer 13. The rectifying circuit 14 may include the transistors SE and SF. The transistors SE and SF may be switching devices that perform switching operations based on driving signals GE and GF, respectively. The transistors SE and SF may each include an N-type field-effect transistor, for example. The transistors SE and SF may each include a body diode, as with each of the transistors SA to SD. Although the N-type field-effect transistor may be used in this example embodiment, this is non-limiting, and any kind of switching device may be used.

The transistor SE may be configured to couple the second end of the winding 13C of the transformer 13 to the reference voltage line L22 when turned on. The transistor SE may include a drain coupled to the second end of the winding 13C of the transformer 13, a gate adapted to receive the driving signal GE, and a source coupled to the reference voltage line L22. The transistor SF may be configured to couple the first end of the winding 13B of the transformer 13 to the reference voltage line L22 when turned on. The transistor SF may include a drain coupled to the first end of the winding 13B of the transformer 13, a gate adapted to receive the driving signal GF, and a source coupled to the reference voltage line L22.

The smoothing circuit 20 may be configured to smooth a voltage rectified by the rectifying circuit 14. The smoothing circuit 20 may include an inductor 21 and a capacitor 22. The inductor 21 may have a first end coupled to the voltage line L21A, and a second end coupled to the voltage line L21B. The capacitor 22 may have a first end coupled to the voltage line L21B, and a second end coupled to the reference voltage line L22.

The voltage sensor 15 may be configured to detect a voltage VL at the voltage line L21B. The voltage sensor 15 may have a first end coupled to the voltage line L21B, and a second end coupled to the reference voltage line L22. The voltage VL may be a voltage at the voltage line L21B with respect to a voltage at the reference voltage line L22. The voltage sensor 15 may detect the voltage VL and supply a detection result on the voltage VL to the control circuit 19.

The control circuit 19 may be configured to control an operation of the electric power conversion apparatus 1 by controlling the switching operation of the switching circuit 12 and the switching operation of the rectifying circuit 14, based on the detection result obtained by the voltage sensor 15. The control circuit 19 may generate control signals GA1 to GD1 and control the switching operation of the switching circuit 12 through the driving circuit 31 by using the control signals GA1 to GD1. Further, the control circuit 19 may generate control signals GE1 and GF1 and control the switching operation of the rectifying circuit 14 through the driving circuit 32 by using the control signals GE1 and GF1. The control circuit 19 may control the switching operation of the switching circuit 12 and the switching operation of the rectifying circuit 14 to allow the voltage VL to remain at a predetermined value, based on the detection result obtained by the voltage sensor 15. Further, the control circuit 19 may operate based on an instruction supplied from an external apparatus through the interface circuit 33. The control circuit 19 may include a microcontroller, for example.

The driving circuit 31 may be configured to drive the transistors SA to SD of the switching circuit 12, based on the control signals GAI to GD1. The driving circuit 31 may generate the driving signals GA to GD, based on the control signals GA1 to GD1, respectively, and may drive the transistors SA to SD through the driving signals GA to GD, respectively. Further, based on a driving control signal SCTL1 supplied to an enable terminal ENB, the driving circuit 31 may start an operation of driving the transistors SA to SD or stop the operation of driving the transistors SA to SD.

The capacitor C1 may have a first end coupled to the enable terminal ENB of the driving circuit 31, and a second end that is grounded.

The driving circuit 32 may be configured to drive the transistors SE and SF of the rectifying circuit 14, based on the control signals GE1 and GF1. The driving circuit 32 may generate the driving signals GE and GF, respectively based on the control signals GE1 and GF1, and may drive the transistors SE and SF through the driving signals GE and GF, respectively. Further, based on a driving control signal SCTL2 supplied to an enable terminal ENB, the driving circuit 32 may start an operation of driving the transistors SE and SF or stop the operation of driving the transistors SE and SF. The driving control signal SCTL2 may correspond to a driving control signal SCTL to be described later.

The capacitor C2 may have a first end coupled to the enable terminal ENB of the driving circuit 32, and a second end that is grounded.

The interface circuit 33 may be configured to communicate with the external apparatus that is unillustrated. The interface circuit 33 may, for example, receive instructions from the external apparatus and transmit the instructions to the control circuit 19. Further, for example, the interface circuit 33 may transmit, to the external apparatus, data on an operation state of the electric power conversion apparatus 1 supplied from the control circuit 19 Further, for example, when an instruction to start or stop the switching operation is received from the external apparatus, the interface circuit 33 may generate the driving control signal SCTL in accordance with the instruction and output the generated driving control signal SCTL from an output terminal CTL. The interface circuit 33 may include a microcontroller, for example.

The signal generation circuit 34 may be configured to generate the driving control signal SCTL1, based on the driving control signal SCTL generated by the interface circuit 33 and the driving signal GE generated by the driving circuit 32.

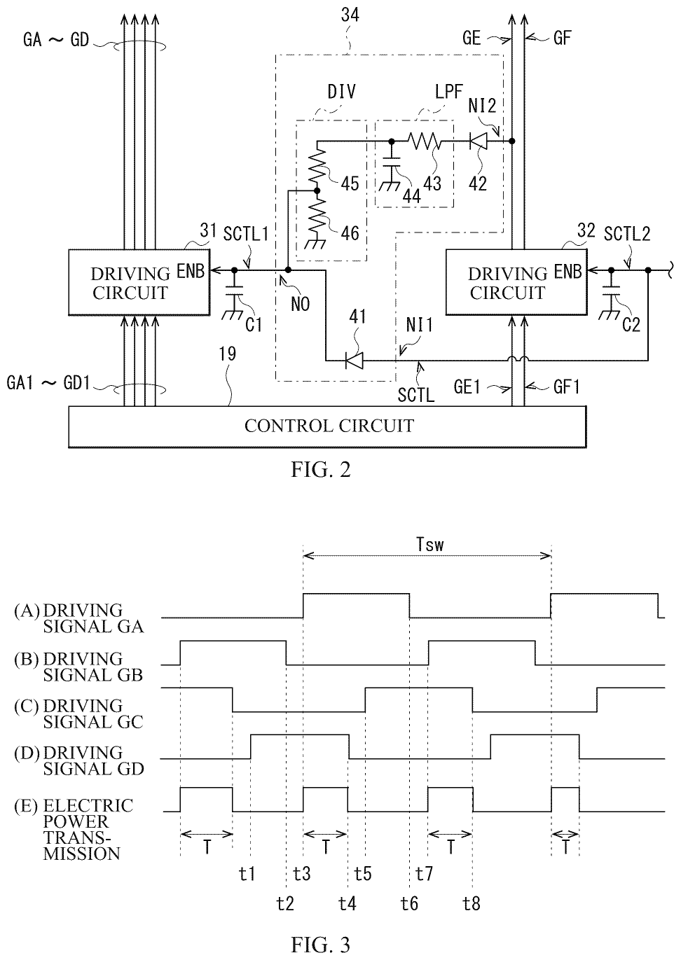

FIG. 2 illustrates a configuration example of the signal generation circuit 34. FIG. 2 also illustrates the control circuit 19, the driving circuits 31 and 32, and the capacitors Cl and C2, in addition to the signal generation circuit 34.

The signal generation circuit 34 may include diodes 41 and 42, a resistor 43, a capacitor 44, and resistors 45 and 46. The signal generation circuit 34 may include input nodes NI1 and NI2 and an output node NO. The input node NI1 may receive the driving control signal SCTL from the interface circuit 33. The input node NI2 may receive the driving signal GE from the driving circuit 32. The output node NO may be coupled to the enable terminal ENB of the driving circuit 31.

The diode 41 may include an anode coupled to the input node NI1, and a cathode coupled to the output node NO. The diode 42 may include an anode coupled to the input node NI2, and a cathode coupled to a first end of the resistor 43.

The resistor 43 may have the first end coupled to the cathode of the diode 42, and a second end coupled to a first end of the capacitor 44 and a first end of the resistor 45. The capacitor 44 may have the first end coupled to the second end of the resistor 43 and the first end of the resistor 45, and a second end that is grounded. The resistor 43 and the capacitor 44 may configure a low-pass filter LPF.

The resistor 45 may have the first end coupled to the second end of the resistor 43 and the first end of the capacitor 44, and a second end coupled to the output node NO. The resistor 46 may have a first end coupled to the output node NO, and a second end that is grounded. The resistors 45 and 46 may configure a voltage divider circuit DIV.

With this configuration, the signal generation circuit 34 generates the driving control signal SCTL1, based on the driving control signal SCTL and the driving signal GE. Thus, when stopping the switching operation in the electric power conversion apparatus 1, the driving circuit 32 may stop generating the driving signals GE and GF first, and thereafter the driving circuit 31 may stop generating the driving signals GA to GD.

Here, the input electric power terminals T11 and T12 may correspond to a specific but non-limiting example of an “input electric power terminal” in one embodiment of the disclosure. The switching circuit 12 may correspond to a specific but non-limiting example of a “switching circuit” in one embodiment of the disclosure. The driving circuit 31 may correspond to a specific but non-limiting example of a “first driving circuit” in one embodiment of the disclosure. The driving control signal SCTL1 may correspond to a specific but non-limiting example of a “first driving control signal” in one embodiment of the disclosure. The transformer 13 may correspond to a specific but non-limiting example of a “transformer” in one embodiment of the disclosure. The winding 13A may correspond to a specific but non-limiting example of a “first winding” in one embodiment of the disclosure. The winding 13C may correspond to a specific but non-limiting example of a “second winding” in one embodiment of the disclosure. The rectifying circuit 14 may correspond to a specific but non-limiting example of a “rectifying circuit” in one embodiment of the disclosure. The transistor SE may correspond to a specific but non-limiting example of a “first rectification switching device” in one embodiment of the disclosure. The driving circuit 32 may correspond to a specific but non-limiting example of a “second driving circuit” in one embodiment of the disclosure. The driving signal GE may correspond to a specific but non-limiting example of a “first driving signal” in one embodiment of the disclosure. The driving control signal SCTL2 may correspond to a specific but non-limiting example of a “second driving control signal” in one embodiment of the disclosure. The signal generation circuit 34 may correspond to a specific but non-limiting example of a “signal generation circuit” in one embodiment of the disclosure. The driving control signal SCTL may correspond to a specific but non-limiting example of a “control signal” in one embodiment of the disclosure. The smoothing circuit 20 may correspond to a specific but non-limiting example of a “smoothing circuit” in one embodiment of the disclosure. The output electric power terminals T21 and T22 may correspond to a specific but non-limiting example of an “output electric power terminal” in one embodiment of the disclosure.

The input node N1 may correspond to a specific but non-limiting example of a “first input node” in one embodiment of the disclosure. The input node NI2 may correspond to a specific but non-limiting example of a “second input node” in one embodiment of the disclosure. The output node NO may correspond to a specific but non-limiting example of an “output node” in one embodiment of the disclosure. The diode 41 may correspond to a specific but non-limiting example of a “first diode” in one embodiment of the disclosure. The diode 42 may correspond to a specific but non-limiting example of a “second diode” in one embodiment of the disclosure. The low-pass filter LPF may correspond to a specific but non-limiting example of a “low-pass filter” in one embodiment of the disclosure. The voltage divider circuit DIV may correspond to a specific but non-limiting example of a “voltage divider circuit” in one embodiment of the disclosure. The resistors 45 and 46 may correspond to a specific but non-limiting example of “resistors” in one embodiment of the disclosure.

### Operation and Workings

Next, a description will be given of operation and workings of the electric power conversion apparatus 1 of the example embodiment.

### Outline of Overall Operation

First, an outline of overall operation of the electric power conversion apparatus 1 will be described with reference to FIG. 1. The driving circuit 31 may generate the driving signal GA to GD, based on the control signals GAI to GD1, respectively. The switching circuit 12 may convert a direct-current voltage supplied from the high voltage battery BH into an alternating-current voltage by performing the switching operation, based on the driving signals GA to GD. The transformer 13 may provide direct-current isolation and alternating-current coupling between the primary-side circuitry and the secondary-side circuitry. The transformer 13 may convert the alternating-current voltage supplied from the primary-side circuitry with the transformation ratio of the transformer 13 and supply the converted alternating-current voltage to the secondary-side circuitry. The driving circuit 32 may generate the driving signals GE and GF, based on the control signals GEI and GF1, respectively. The rectifying circuit 14 may rectify the alternating-current voltage outputted from the windings 13B and 13C of the transformer 13, by performing the switching operation, based on the driving signals GE and GF. The smoothing circuit 20 smooths the voltage rectified by the rectifying circuit 14. The voltage sensor 15 may detect the voltage VL at the voltage line L21A. The control circuit 19 may control the operation of the electric power conversion apparatus 1 by controlling the switching operation of the switching circuit 12 and the switching operation of the rectifying circuit 14, based on the detection result obtained by the voltage sensor 15. The control circuit 19 may generate the control signals GA1 to GD1 and control the switching operation of the switching circuit 12 through the driving circuit 31 by using the control signals GA1 to GD1. Further, the control circuit 19 may generate the control signals GE1 and GF1 and control the switching operation of the rectifying circuit 14 through the driving circuit 32 by using the control signals GE1 and GF1.

The interface circuit 33 may, for example, receive instructions from the external apparatus and transmit the instructions to the control circuit 19. Further, for example, the interface circuit 33 may transmit, to the external apparatus, data on the operation state of the electric power conversion apparatus 1 supplied from the control circuit 19. Further, for example, when an instruction to start or stop the switching operation is received from the external apparatus, the interface circuit 33 may generate the driving control signal SCTL in accordance with the instruction and output the generated driving control signal SCTL from the output terminal CTL. The driving circuit 32 may start the operation of driving the transistors SE and SF or stop the operation of driving the transistors SE and SF, based on the driving control signal SCTL2 that corresponds to the driving control signal SCTL and is supplied to the enable terminal ENB. The signal generation circuit 34 generates the driving control signal SCTL1, based on the driving control signal SCTL and the driving signal GE. The driving circuit 31 may start the operation of driving the transistors SA to SD or stop the operation of driving the transistors SA to SD, based on the driving control signal SCTL1 supplied to the enable terminal ENB.

### Detailed Operation

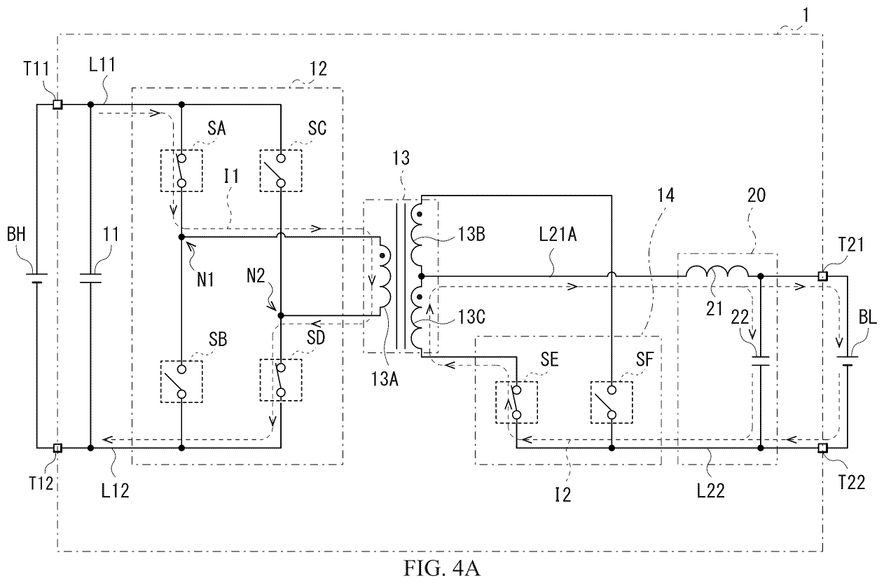

FIG. 3 illustrates an operation example of the electric power conversion apparatus 1. Parts (A) to (D) of FIG. 3 illustrate respective waveforms of the driving signals GA to GD, and part (E) of FIG. 3 illustrates an operation of transmitting electric power from the primary-side circuitry to the secondary-side circuitry in the electric power conversion apparatus 1. The electric power conversion apparatus 1 may perform electric power transmission from the primary-side circuitry to the secondary-side circuitry in a period T during which the waveform illustrated in part (E) of FIG. 3 is at a high level.

At a timing t1, the driving circuit 31 may change the driving signal GD from a low level to a high level, as illustrated in part (D) of FIG. 3, based on the control signal GD1. This may cause the transistor SD to change from an off-state to an on-state.

Thereafter, at a timing t2, the driving circuit 31 may change the driving signal GB from the high level to the low level, as illustrated in part (B) of FIG. 3, based on the control signal GB1. This may cause the transistor SB to change from the on-state to the off-state.

Thereafter, at a timing t3, the driving circuit 31 may change the driving signal GA from the low level to the high level, as illustrated in part (A) of FIG. 3, based on the control signal GA1. This may cause the transistor SA to change from the off-state to the on-state.

Thereafter, at a timing t4, the driving circuit 31 may change the driving signal GD from the high level to the low level, as illustrated in part (D) of FIG. 3, based on the control signal GD1. This may cause the transistor SD to change from the on-state to the off-state.

In this way, the transistors SA and SD may both be brought into the on-state during a period T from the timing t3 to the timing t4. During this period T, both the driving signals GB and GC may be at the low level, which may cause both the transistors SB and SC to be in the off-state.

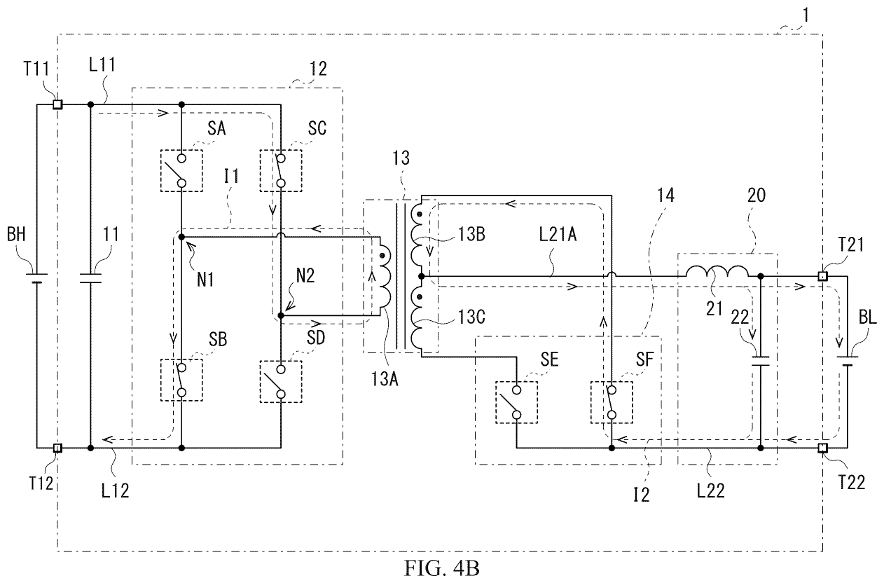

FIG. 4A illustrates an operation state of the electric power conversion apparatus 1 at a certain timing in the period T from the timing t3 to the timing t4. For convenience of description, the electric power conversion apparatus 1 is illustrated in a simplified manner in FIG. 4A. Further, the transistors SA to SF are illustrated as switches indicating their on/off states. During this period, the transistor SE may be in the on-state and the transistor SF may be in the off-state.

Owing to the transistors SA and SD being in the on-state, in the primary-side circuitry of the electric power conversion apparatus 1, a current I1 may flow through the voltage line L11, the transistor SA, the winding 13A, the transistor SD, and the reference voltage line L12 in this order. Accordingly, in the secondary-side circuitry of the electric power conversion apparatus 1, a current 12 may flow through the winding 13C, the inductor 21, the capacitor 22 and the low voltage battery BL, the reference voltage line L22, the transistor SE, and the winding 13C in this order. In this way, the electric power conversion apparatus 1 may transmit electric power from the primary-side circuitry to the secondary-side circuitry during the period T from the timing t3 to the timing t4.

Thereafter, at a timing t5, the driving circuit 31 may change the driving signal GC from the low level to the high level, as illustrated in part (C) of FIG. 3, based on the control signal GC1. This may cause the transistor SC to change from the off-state to the on-state.

Thereafter, at a timing t6, the driving circuit 31 may change the driving signal GA from the high level to the low level, as illustrated in part (A) of FIG. 3, based on the control signal GA1. This may cause the transistor SA to change from the on-state to the off-state.

Thereafter, at a timing t7, the driving circuit 31 may change the driving signal GB from the low level to the high level, as illustrated in part (B) of FIG. 3, based on the control signal GB1. This may cause the transistor SB to change from the off-state to the on-state.

Thereafter, at a timing t8, the driving circuit 31 may change the driving signal GC from the high level to the low level, as illustrated in part (C) of FIG. 3, based on the control signal GC1. This may cause the transistor SC to change from the on-state to the off-state.

In this way, the transistors SB and SC may both be brought into the on-state during a period T from the timing t7 to the timing t8. During this period T, both the driving signals GA and GD may be at the low level, which may cause both the transistors SA and SD to be in the off-state.

FIG. 4B illustrates an operation state of the electric power conversion apparatus 1 at a certain timing in the period T from the timing t7 to the timing t8. During this period, the transistor SE may be in the off-state and the transistor SF may be in the on-state.

Owing to the transistors SB and SC being in the on-state, in the primary-side circuitry of the electric power conversion apparatus 1, the current I1 may flow through the voltage line L11, the transistor SC, the winding 13A, the transistor SB, and the reference voltage line L12 in this order. Accordingly, in the secondary-side circuitry of the electric power conversion apparatus 1, the current 12 may flow through the winding 13B, the inductor 21, the capacitor 22 and the low-voltage battery BL, the reference voltage line L22, the transistor SF, and the winding 13B in this order. In this way, the electric power conversion apparatus 1 may transmit electric power from the primary-side circuitry to the secondary-side circuitry during the period T from the timing t7 to the timing t8.

In the manner described above, the electric power conversion apparatus 1 may transmit electric power from the primary-side circuitry to the secondary-side circuitry during the period T from the timing t3 to the timing t4 and the period T from the timing t7 to the timing t8.

Based on the voltage VL as an output voltage of the electric power conversion apparatus 1, the control circuit 19 may determine a duty ratio of the two periods T, that is, a ratio of a duration of the periods T during which electric power transmission is to be performed to a duration of a period Tsw corresponding to a switching period of the driving signals GA to GD, for example. Thereafter, based on the duty ratio, the control circuit 19 may generate the control signals GA1 to GD1 serving as a basis to generate the driving signals GA to GD. For example, when the voltage VL is lower than a target voltage, the control circuit 19 may attempt to increase the voltage VL by increasing the duty ratio. For example, when the voltage VL is higher than the target voltage, the control circuit 19 may attempt to decrease the voltage VL by decreasing the duty ratio. In this way, the control circuit 19 may perform feedback control to cause the voltage VL to become equal to the target voltage.

### Operation Based on Instruction from External Apparatus

When an external apparatus has instructed the electric power conversion apparatus 1 to start or stop the switching operation, the interface circuit 33 of the electric power conversion apparatus 1 may generate the driving control signal SCTL in accordance with the instruction. Based on this driving control signal SCTL, the electric power conversion apparatus 1 may start or stop the switching operation. Details of this operation will be described below.

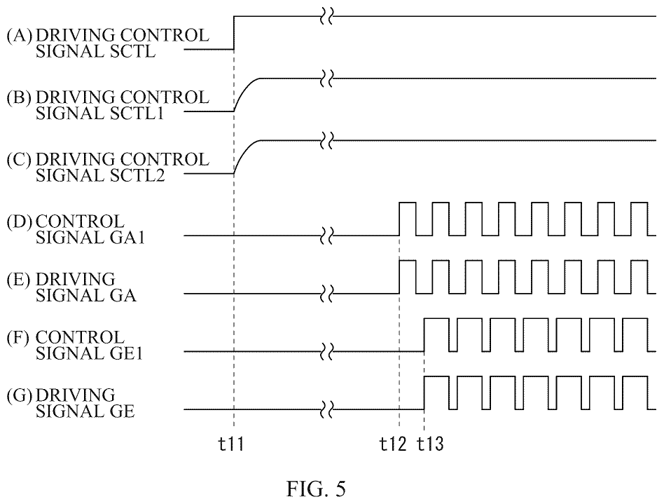

FIG. 5 illustrates an example of operation of the electric power conversion apparatus 1 when the external apparatus has instructed the electric power conversion apparatus 1 to start the switching operation. In FIG. 5, part (A) illustrates a waveform of the driving control signal SCTL, part (B) illustrates a waveform of the driving control signal SCTL1 at the enable terminal ENB of the driving circuit 31, part (C) illustrates a waveform of the driving control signal SCTL2 at the enable terminal ENB of the driving circuit 32, part (D) illustrates a waveform of the control signal GA1, part (E) illustrates a waveform of the driving signal GA, part (F) illustrates a waveform of the control signal GE1, and part (G) illustrates a waveform of the driving signal GE. Note that the control signals GB1, GC1, and GD1 may each have a waveform similar to the waveform of the control signal GA1 illustrated in part (D) of FIG. 5, and the driving signals GB, GC, and GD may each have a waveform similar to the waveform of the driving signal GA illustrated in part (E) of FIG. 5. Further, the control signal GF1 may have a waveform similar to the waveform of the control signal GE1 illustrated in part (F) of FIG. 5, and the driving signal GF may have a waveform similar to the waveform of the driving signal GE illustrated in part (G) of FIG. 5.

Upon receiving an instruction to start the switching operation transmitted from the external terminal, the interface circuit 33 of the electric power conversion apparatus 1 may change the driving control signal SCTL from the low level to the high level at a timing t11, as illustrated in part (A) of FIG. 5. The capacitor C2 may thus be charged to increase a voltage of the driving control signal SCTL2 at the enable terminal ENB of the driving circuit 32, as illustrated in part (C) of FIG. 5. As a result, the driving circuit 32 may become able to generate the driving signals GE and GF, based on the control signals GE1 and GF1, respectively. Note that because the control signals GE1 and GF1 are not generated yet, the driving circuit 32 may keep the driving signals GE and GF at the low level (see parts (F) and (G) of FIG. 5).

Further, at the timing t11, the change of the driving control signal SCTL to the high level may bring the diode 41 of the signal generation circuit 34 into the on-state transiently, which may allow the capacitor C1 to be charged to increase a voltage of the driving control signal SCTL1 at the enable terminal ENB of the driving circuit 31, as illustrated in part (B) of FIG. 5. As a result, the driving circuit 31 may become able to generate the driving signals GA to GD, based on the control signals GA1 to GD1, respectively. Note that because the control signals GA1 to GD1 are not generated yet, the driving circuit 32 may keep the driving signals GA to GD at the low level (see parts (D) and (E) of FIG. 5).

Thereafter, at a timing t12, the control circuit 19 may start generating the control signals GA1 to GD1 (see part (D) of FIG. 5). The driving circuit 31 may start generating the driving signals GA to GD, based on the control signals GA1 to GD1, respectively (see part (E) of FIG. 5).

Thereafter, at a timing t13 after the timing t12, the control circuit 19 may start generating the control signals GE1 and GF1 (see part (F) of FIG. 5). The driving circuit 32 may start generating the driving signals GE and GF, based on the control signals GE1 and GF1, respectively (see part (G) of FIG. 5).

In this way, when starting the switching operation in the electric power conversion apparatus 1, the control circuit 19 may start generating the control signals GA1 to GD1 first and thereafter start generating the control signals GE1 and GF1. This may cause the driving circuit 32 to start generating the driving signals GE and GF after the driving circuit 31 starts generating the driving signals GA to GD. As a result, in the electric power conversion apparatus 1, the rectifying circuit 14 in the secondary-side circuitry may start operating after the switching circuit 12 in the primary-side circuitry starts operating. The electric power conversion apparatus 1 may thus have no period in which the rectifying circuit 14 alone performs the switching operation. This helps to lower a possibility of an occurrence of a surge in the rectifying circuit 14, for example.

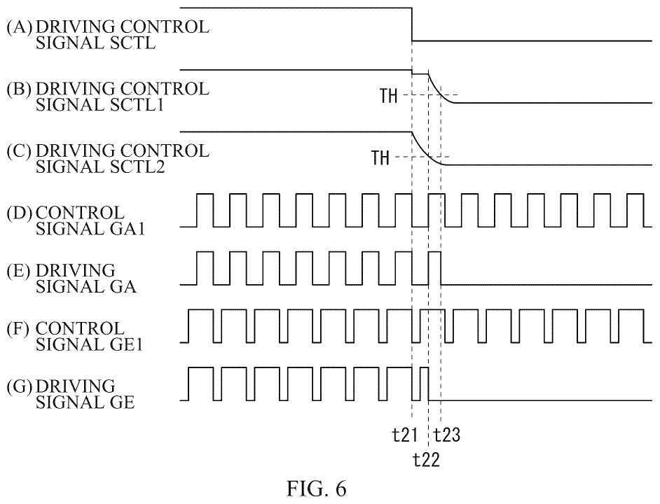

FIG. 6 illustrates an example of operation of the electric power conversion apparatus 1 when the external apparatus has instructed the electric power conversion apparatus 1 to stop the switching operation. In FIG. 6, part (A) illustrates the waveform of the driving control signal SCTL, part (B) illustrates the waveform of the driving control signal SCTL1 at the enable terminal ENB of the driving circuit 31, part (C) illustrates the waveform of the driving control signal SCTL2 at the enable terminal ENB of the driving circuit 32, part (D) illustrates the waveform of the control signal GA1, part (E) illustrates the waveform of the control signal GA, part (F) illustrates the waveform of the control signal GE1, and part (G) illustrates the waveform of the driving signal GE.

Upon receiving an instruction to stop the switching operation transmitted from the external terminal, the interface circuit 33 of the electric power conversion apparatus 1 may change the driving control signal SCTL from the high level to the low level at a timing t21, as illustrated in part (A) of FIG. 6. The capacitor C2 may thus be discharged to decrease the voltage of the driving control signal SCTL2 at the enable terminal ENB of the driving circuit 32, as illustrated in part (C) of FIG. 6. At a timing t22, the voltage of the driving control signal SCTL2 may fall below a threshold voltage TH, and the driving circuit 32 may thus stop generating the driving signals GE and GF, based on the driving control signal SCTL2 (see part (G) of FIG. 6).

In a period from the timing t21 to the timing t22 after the change of the driving control signal SCTL to the low level at the timing t21, the driving circuit 32 may be generating the driving signal GE and accordingly, the signal generation circuit 34 may keep the voltage of the driving control signal SCTL1 at the enable terminal ENB of the driving circuit 31 at a high value, as illustrated in part (B) of FIG. 6. Thereafter, once the driving circuit 32 stops generating the driving signals GE and GF at the timing t22, the driving signal GE may be kept at the low level, as illustrated in part (G) of FIG. 6, and accordingly, the signal generation circuit 34 may decrease the voltage of the driving control signal SCTL1, as illustrated in part (B) of FIG. 6. At a timing t23, the voltage of the driving control signal SCTL1 may fall below the threshold voltage TH, and the driving circuit 31 may thus stop generating the driving signals GA to GD, based on the driving control signal SCTL1 (see part (E) of FIG. 6).

In this way, when stopping the switching operation in the electric power conversion apparatus 1, the driving circuit 32 may stop generating the driving signals GE and GF first, based on the driving control signal SCTL2 corresponding to the driving control signal SCTL. This may change the driving signal GE to the low level. Based on the driving signal GE, the signal generation circuit 34 may decrease the voltage of the driving control signal SCTL1 at the enable terminal ENB of the driving circuit 31. Based on the driving control signal SCTL1, the driving circuit 31 may stop generating the driving signals GA to GD. As a result, in the electric power conversion apparatus 1, the switching circuit 12 in the primary-side circuitry may stop operating after the rectifying circuit 14 in the secondary-side circuitry stops operating. The electric power conversion apparatus 1 may thus have no period in which the rectifying circuit 14 alone performs the switching operation. This helps to lower the possibility of the occurrence of a surge in the rectifying circuit 14, for example.

As described above, the electric power conversion apparatus 1 includes the input electric power terminals T11 and T12, the switching circuit 12, the first driving circuit (the driving circuit 31), the transformer 13, the rectifying circuit 14, the second driving circuit (the driving circuit 32), the signal generation circuit 34, the smoothing circuit 20, and the output electric power terminals T21 and T22. The switching circuit 12 is coupled to the input electric power terminals T11 and T12 and is configured to perform the switching operation. The first driving circuit (the driving circuit 31) is configured to perform a first driving operation of driving the switching circuit 12, and configured to stop the first driving operation, based on the first driving control signal (the driving control signal SCTL1). The transformer 13 includes the first winding (the winding 13A) and the second winding (the winding 13C). The first winding (the winding 13A) is led to the switching circuit 12. The rectifying circuit 14 includes the first rectification switching device (the transistor SE) coupled to the second winding (the winding 13C) and configured to be turned on and off based on the first driving signal (the driving signal GE). The rectifying circuit 14 is configured to rectify a signal supplied from the second winding (the winding 13C), by performing the switching operation. The second driving circuit (the driving circuit 32) is configured to generate the first driving signal (the driving signal GE), configured to perform a second driving operation that includes driving the first rectification switching device (the transistor SE) through the first driving signal (the driving signal GE), and configured to stop the second driving operation, based on the second driving control signal (the driving control signal SCTL2) corresponding to the control signal (the driving control signal SCTL). The signal generation circuit 34 is configured to generate the first driving control signal (the driving control signal SCTL1), based on the control signal (the driving control signal SCTL) and the first driving signal (the driving signal GE). The smoothing circuit 20 is configured to smooth a voltage rectified by the rectifying circuit 14. The output electric power terminals T21 and T22 are coupled to the smoothing circuit 20. In this way, in the electric power conversion apparatus 1, the signal generation circuit 34 generates the driving control signal SCTL1, based on the driving control signal SCTL and the driving signal GE, and the driving circuit 31 stops the operation of driving the transistors SA to SD, based on the driving control signal SCTL1. For example, as illustrated in FIG. 6, the driving circuit 31 may stop generating the driving signals GA to GD, based on a result in which the driving circuit 32 has stopped generating the driving signal GE. This helps to allow the electric power conversion apparatus 1 to achieve increased robustness of the operation of stopping the switching operation.

For example, according to the technique disclosed in JP-A No. 2004-215356, characteristic variations between devices or circuits can sometimes lead to a possibility that the switching circuit in the primary-side circuitry fails to stop operating after the rectifying circuit in the secondary-side circuitry stops operating. In contrast, in the electric power conversion apparatus 1 according to the example embodiment, the driving circuit 31 may stop generating the driving signals GA to GD, based on the result in which the driving circuit 32 has stopped generating the driving signal GE. This operation is less susceptible to variations between devices or circuits. Accordingly, the electric power conversion apparatus 1 helps to increase the robustness of the operation of stopping the switching operation.

Further, the increased robustness described above helps to shorten a length of time from when the generation of the driving signal GE is stopped to when the generation of the driving signals GA to GD is stopped. For example, in a case of a circuit with low robustness, a length of time from when the rectifying circuit in the secondary-side circuitry stops operating to when the switching circuit in the primary-side circuitry stops operating may be set to be relatively long in order to increase the robustness. In such a case, however, it is difficult to stop the operation of the electric power conversion apparatus 1 in a short time. For example, in the event of an overcurrent or overvoltage, the electric power conversion apparatus 1 has to be stopped in a short time; however, the circuit with low robustness would make it difficult to stop the operation of the electric power conversion apparatus 1 in a short time. In contrast, in the electric power conversion apparatus 1 according to the example embodiment, the increased robustness described above helps to shorten the length of time from when the rectifying circuit in the secondary-side circuitry stops operating to when the switching circuit in the primary-side circuitry stops operating.

In some embodiments, in the electric power conversion apparatus 1, the signal generation circuit 34 may include the first input node (the input node NI1), the second input node (the input node NI2), the output node (the output node NO), the first diode (the diode 41), and the second diode (the diode 42). The first input node (the input node NI1) may be configured to receive the control signal (the driving control signal SCTL). The second input node (the input node NI2) may be configured to receive the first driving signal (the driving signal GE). The output node (the output node NO) may be configured to output the first driving control signal (the driving control signal SCTL1). The first diode (the diode 41) may be provided in a path coupling the first input node (the input node NI1) and the output node (the output node NO) to each other, and may include the anode led to the first input node (the input node NI1) and the cathode led to the output node (the output node NO). The second diode (the diode 42) may be provided in a path coupling the second input node (the input node NI2) and the output node (the output node NO) to each other, and may include the anode led to the second input node (the input node NI2) and the cathode led to the output node (the output node NO). With such a configuration, in the electric power conversion apparatus 1, when the driving control signal SCTL changes from the high level to the low level, for example, a voltage of the anode of the diode 41 may become lower than a voltage of the cathode of the diode 41, which may bring the diode 41 into the off-state. Thereafter, when the generation of the driving signal GE is stopped and the driving signal GE drops to the low level, a voltage of the anode of the diode 42 may become lower than a voltage of the cathode of the diode 42, which may bring the diode 42 into the off-state. Thereafter, the capacitor C1 may be discharged and the driving control signal SCTL1 may drop to the low level. In such a manner, in the electric power conversion apparatus 1, based on the result in which the driving circuit 32 has stopped generating the driving signal GE, the driving control signal SCTL1 may drop to the low level to cause the driving circuit 31 to stop generating the driving signals GA to GD. This helps to allow the electric power conversion apparatus 1 to increase the robustness of the operation of stopping the switching operation with a simple configuration.

### Example Effects

As described above, an electric power conversion apparatus according to at least one embodiment of the disclosure includes an input electric power terminal, a switching circuit, a first driving circuit, a transformer, a rectifying circuit, a second driving circuit, a signal generation circuit, a smoothing circuit, and an output electric power terminal. The switching circuit is coupled to the input electric power terminal and is configured to perform a switching operation. The first driving circuit is configured to perform a first driving operation of driving the switching circuit, and configured to stop the first driving operation, based on a first driving control signal. The transformer includes a first winding and a second winding. The first winding is led to the switching circuit. The rectifying circuit includes a first rectification switching device coupled to the second winding and configured to be turned on and off based on a first driving signal. The rectifying circuit is configured to rectify a signal supplied from the second winding, by performing a switching operation. The second driving circuit is configured to generate the first driving signal, configured to perform a second driving operation that includes driving the first rectification switching device through the first driving signal, and configured to stop the second driving operation, based on a second driving control signal corresponding to a control signal. The signal generation circuit is configured to generate the first driving control signal, based on the control signal and the first driving signal. The smoothing circuit is configured to smooth a voltage rectified by the rectifying circuit. The output electric power terminal is coupled to the smoothing circuit. This helps to achieve increased robustness of the operation of stopping the switching operation.

In some embodiments, the signal generation circuit may include a first input node, a second input node, an output node, a first diode, and a second diode. The first input node may be configured to receive the control signal. The second input node may be configured to receive the first driving signal. The output node may be configured to output the first driving control signal. The diode may be provided in a path coupling the first input node and the output node to each other, and may include an anode led to the first input node and a cathode led to the output node. The second diode may be provided in a path coupling the second input node and the output node to each other, and may include an anode led to the second input node and a cathode led to the output node. This helps to achieve increased robustness of the operation of stopping the switching operation with a simple configuration.

### Modification Example 1

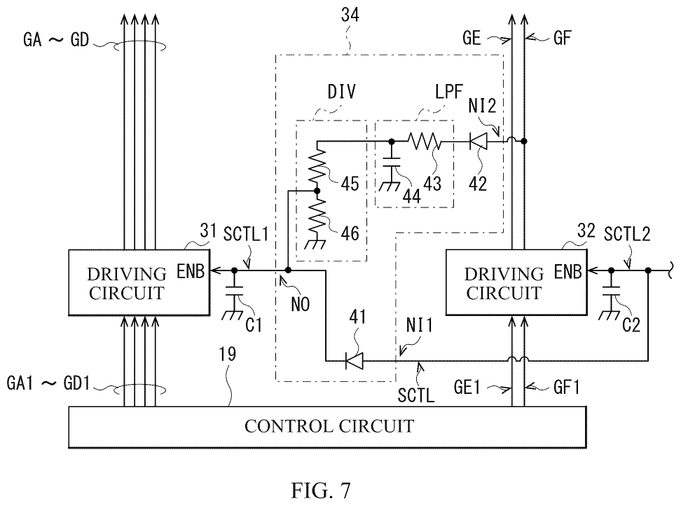

In the foregoing example embodiment, the signal generation circuit 34 generates the driving control signal SCTL1, based on the driving control signal SCTL and the driving signal GE; however, this is non-limiting. In some embodiments, as illustrated in FIG. 7, the signal generation circuit 34 may generate the driving control signal SCTL1, based on the driving control signal SCTL and the driving signal GF, for example.

### Modification Example 2

In the foregoing example embodiment, the signal generation circuit 34 may generate the driving control signal SCTL1, based on either the driving signal GE or the driving signal GF; however, this is non-limiting. In some embodiments, the signal generation circuit 34 may generate the driving control signal SCTL1, based on both the driving signal GE and the driving signal GF, for example. The present modification example will be described in detail below.

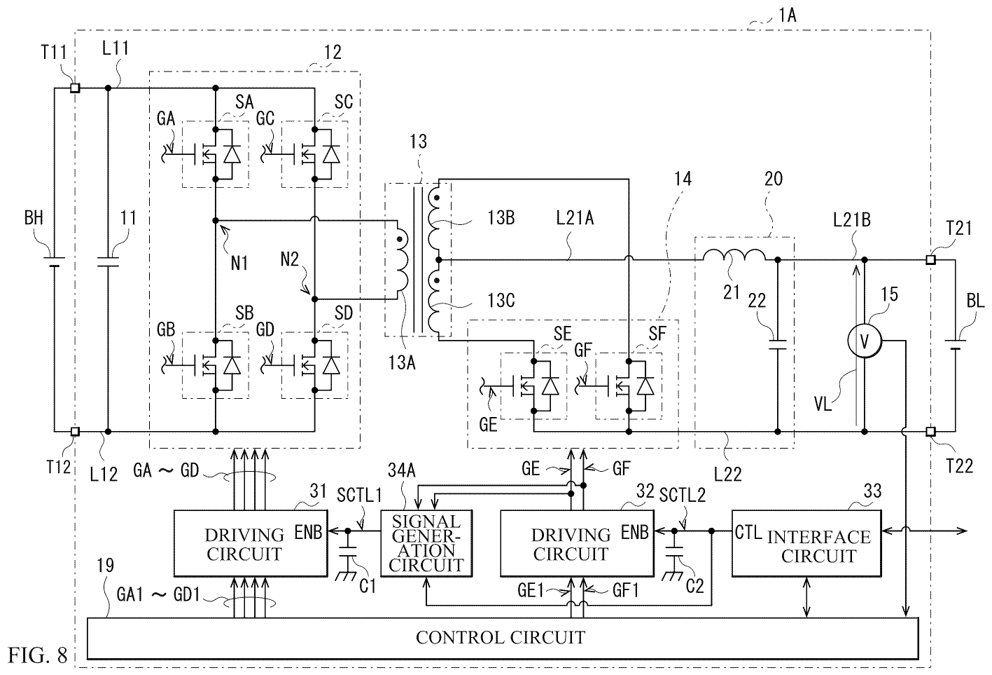

FIG. 8 illustrates a configuration example of an electric power conversion apparatus 1A according to the present modification example. The electric power conversion apparatus 1A includes a signal generation circuit 34A. The signal generation circuit 34A may be configured to generate the driving control signal SCTL1, based on the driving control signal SCTL generated by the interface circuit 33 and the driving signals GE and GF generated by the driving circuit 32.

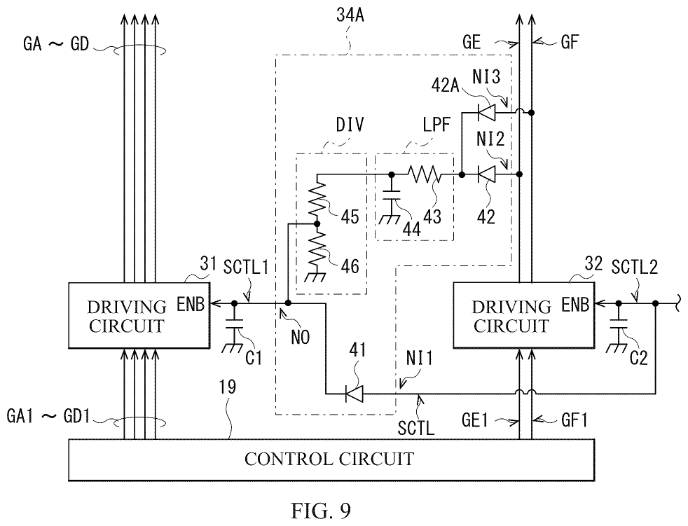

FIG. 9 illustrates a configuration example of the signal generation circuit 34A. The signal generation circuit 34A may include a diode 42A. The signal generation circuit 34A may include an input node NI3 that receives the driving signal GF from the driving circuit 32. The diode 42A may include an anode coupled to the input node NI3, and a cathode coupled to the first end of the resistor 43.

Here, the winding 13B may correspond to a specific but non-limiting example of a “third winding” in one embodiment of the disclosure. The transistor SF may correspond to a specific but non-limiting example of a “second rectification switching device” in one embodiment of the disclosure. The driving signal GF may correspond to a specific but non-limiting example of a “second driving signal” in one embodiment of the disclosure. The signal generation circuit 34A may correspond to a specific but non-limiting example of the “signal generation circuit” in one embodiment of the disclosure. The input node NI3 may correspond to a specific but non-limiting example of a “third input node” in one embodiment of the disclosure. The diode 42A may correspond to a specific but non-limiting example of a “third diode” in one embodiment of the disclosure.

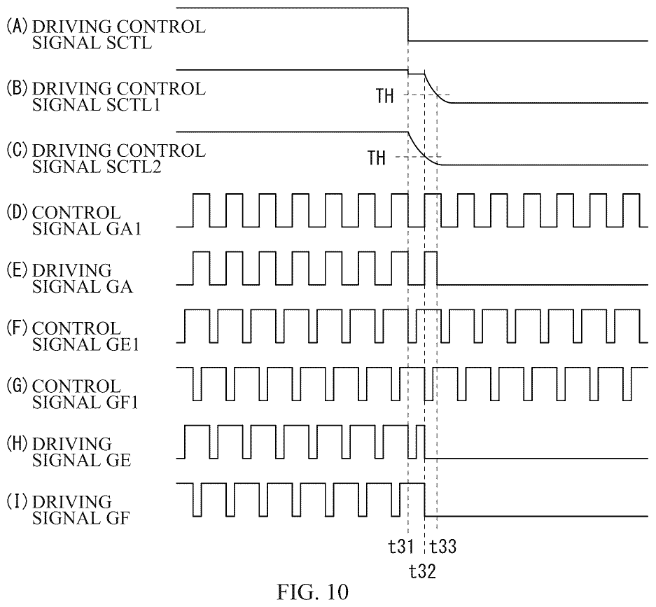

FIG. 10 illustrates an example of operation of the electric power conversion apparatus 1A when the external apparatus has instructed the electric power conversion apparatus 1A to stop the switching operation. In FIG. 10, part (A) illustrates the waveform of the driving control signal SCTL, part (B) illustrates the waveform of the driving control signal SCTL1 at the enable terminal ENB of the driving circuit 31, part (C) illustrates the waveform of the driving control signal SCTL2 at the enable terminal ENB of the driving circuit 32, part (D) illustrates the waveform of the control signal GA1, part (E) illustrates the waveform of the driving signal GA, part (F) illustrates the waveform of the control signal GE1, part (G) illustrates the waveform of the control signal GF1, part (H) illustrates the waveform of the driving signal GE, and part (I) illustrates the waveform of the driving signal GF.

Upon receiving the instruction to stop the switching operation transmitted from the external terminal, the interface circuit 33 of the electric power conversion apparatus 1A may change the driving control signal SCTL from the high level to the low level at a timing t31, as illustrated in part (A) of FIG. 10. The capacitor C2 may thus be discharged to decrease the voltage of the driving control signal SCTL2 at the enable terminal ENB of the driving circuit 32, as illustrated in part (C) of FIG. 10. At a timing t32, the voltage of the driving control signal SCTL2 may fall below the threshold voltage TH, and the driving circuit 32 may thus stop generating the driving signals GE and GF, as illustrated in parts (H) and (I) of FIG. 10, based on the driving control signal SCTL2.

In a period from the timing t31 to the timing t32 after the change of the driving control signal SCTL to the low level at the timing t31, the driving circuit 32 may be generating the driving signals GE and GF, and accordingly, the signal generation circuit 34A may keep the voltage of the driving control signal SCTL1 at the enable terminal ENB of the driving circuit 31 at a high value, as illustrated in part (B) of FIG. 10. Thereafter, once the driving circuit 32 stops generating the driving signals GE and GF at the timing t32, the driving signals GE and GF may be kept at the low level, as illustrated in parts (H) and (I) of FIG. 10, and accordingly, the signal generation circuit 34A may decrease the voltage of the driving control signal SCTL1, as illustrated in part (B) of FIG. 10. At a timing t33, the voltage of the driving control signal SCTL1 may fall below the threshold voltage TH, and the driving circuit 31 may thus stop generating the driving signals GA to GD, based on the driving control signal SCTL1 (see part (E) of FIG. 10).

In such a case also, the switching circuit 12 in the primary-side circuitry may stop operating after the rectifying circuit 14 in the secondary-side circuitry stops operating. The electric power conversion apparatus 1A may thus have no period in which the rectifying circuit 14 alone performs the switching operation. This helps to lower the possibility of the occurrence of a surge in the rectifying circuit 14, for example.

The disclosure has been described hereinabove with reference to the example embodiment and the modification examples. However, the disclosure is not limited thereto, and various modifications may be made.

For example, although the circuit configuration illustrated in FIG. 1 may be employed in the foregoing example embodiment, this is non-limiting. In some embodiments, the switching circuit 12 in the primary-side circuitry may be a half bridge circuit.

The effects described herein are mere examples, and effects of an embodiment of the disclosure are not limited thereto. Accordingly, any other effect may be obtained in relation to the embodiment of the disclosure.

The disclosure encompasses any possible combination of some or all of the various embodiments and the modification examples described herein and incorporated herein. An embodiment of the disclosure may have any of the following configurations.

(1)

An electric power conversion apparatus including:
an input electric power terminal;
a switching circuit coupled to the input electric power terminal and configured to perform a switching operation;
a first driving circuit configured to perform a first driving operation of driving the switching circuit, and configured to stop the first driving operation, based on a first driving control signal;
a transformer including a first winding and a second winding, the first winding being led to the switching circuit;
a rectifying circuit including a first rectification switching device, the first rectification switching device being coupled to the second winding and configured to be turned on and off based on a first driving signal, the rectifying circuit being configured to rectify a signal supplied from the second winding, by performing a switching operation;
a second driving circuit configured to generate the first driving signal, configured to perform a second driving operation that includes driving the first rectification switching device through the first driving signal, and configured to stop the second driving operation, based on a second driving control signal corresponding to a control signal;
a signal generation circuit configured to generate the first driving control signal, based on the control signal and the first driving signal;
a smoothing circuit configured to smooth a voltage rectified by the rectifying circuit; and
an output electric power terminal coupled to the smoothing circuit.
   (2)

The electric power conversion apparatus according to (1), in which the signal generation circuit includes:
a first input node configured to receive the control signal;
a second input node configured to receive the first driving signal;
an output node configured to output the first driving control signal;
a first diode provided in a path coupling the first input node and the output node to each other, the first diode including an anode led to the first input node and a cathode led to the output node; and
a second diode provided in a path coupling the second input node and the output node to each other, the second diode including an anode led to the second input node and a cathode led to the output node.
   (3)

The electric power conversion apparatus according to (2), in which the signal generation circuit further includes a low-pass filter, the low-pass filter being provided in the path coupling the second input node and the output node to each other and being positioned at a stage following the second diode.

(4)

The electric power conversion apparatus according to (2) or (3), in which the signal generation circuit further includes a voltage divider circuit including resistors and configured to divide an inputted voltage, the voltage divider circuit being provided in the path coupling the second input node and the output node to each other and being positioned at a stage following the second diode.

(5)

The electric power conversion apparatus according to (1), in which
the transformer further includes a third winding,
the rectifying circuit further includes a second rectification switching device, the second rectification switching device being coupled to the third winding and configured to be turned on and off based on a second driving signal, the rectifying circuit being further configured to rectify a signal supplied from the third winding,
the second driving circuit is further configured to generate the second driving signal;
the second driving operation further includes driving the second rectification switching device through the second driving signal, and
the signal generation circuit is configured to generate the first driving control signal, based on the control signal, the first driving signal, and the second driving signal.
   (6)

The electric power conversion apparatus according to (5), in which the signal generation circuit includes:
a first input node configured to receive the control signal;
a second input node configured to receive the first driving signal;
a third input node configured to receive the second driving signal;
an output node configured to output the first driving control signal;
a first diode provided in a path coupling the first input node and the output node to each other, the first diode including an anode led to the first input node and a cathode led to the output node;
a second diode provided in a path coupling the second input node and the output node to each other, the second diode including an anode led to the second input node and a cathode led to the output node; and
a third diode provided in a path coupling the third input node and the output node to each other, the third diode including an anode led to the third input node and a cathode led to the output node.

An electric power conversion apparatus according to at least one embodiment of the disclosure makes it possible to achieve increased robustness of an operation of stopping a switching operation.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a,” “an,” and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer or step but not the exclusion of any other non-stated element, integer or step.

The use of the terms first, second, etc. do not denote any order or importance, but rather the terms first, second, etc. are used to distinguish one element from another.

The term “substantially”, “approximately”, “about”, and its variants having the similar meaning thereto are defined as being largely but not necessarily wholly what is specified as understood by one of ordinary skill in the art.

The term “disposed on/provided on/formed on” and its variants having the similar meaning thereto as used herein refer to elements disposed directly in contact with each other or indirectly by having intervening structures therebetween.

What is claimed is:

1. An electric power conversion apparatus comprising:
an input electric power terminal;
a switching circuit coupled to the input electric power terminal and configured to perform a switching operation;
a first driving circuit configured to perform a first driving operation of driving the switching circuit, and configured to stop the first driving operation, based on a first driving control signal;
a transformer including a first winding and a second winding, the first winding being led to the switching circuit;
a rectifying circuit including a first rectification switching device, the first rectification switching device being coupled to the second winding and configured to be turned on and off based on a first driving signal, the rectifying circuit being configured to rectify a signal supplied from the second winding, by performing a switching operation;
a second driving circuit configured to generate the first driving signal, configured to perform a second driving operation that includes driving the first rectification switching device through the first driving signal, and configured to stop the second driving operation, based on a second driving control signal corresponding to a control signal;
a signal generation circuit configured to generate the first driving control signal, based on the control signal and the first driving signal;
a smoothing circuit configured to smooth a voltage rectified by the rectifying circuit; and
an output electric power terminal coupled to the smoothing circuit.

2. The electric power conversion apparatus according to claim 1, wherein the signal generation circuit includes:
a first input node configured to receive the control signal;
a second input node configured to receive the first driving signal;
an output node configured to output the first driving control signal;
a first diode provided in a path coupling the first input node and the output node to each other, the first diode including an anode led to the first input node and a cathode led to the output node; and
a second diode provided in a path coupling the second input node and the output node to each other, the second diode including an anode led to the second input node and a cathode led to the output node.

3. The electric power conversion apparatus according to claim 2, wherein the signal generation circuit further includes a low-pass filter, the low-pass filter being provided in the path coupling the second input node and the output node to each other and being positioned at a stage following the second diode.

4. The electric power conversion apparatus according to claim 2, wherein the signal generation circuit further includes a voltage divider circuit including resistors and configured to divide an inputted voltage, the voltage divider circuit being provided in the path coupling the second input node and the output node to each other and being positioned at a stage following the second diode.

5. The electric power conversion apparatus according to claim 1, wherein
the transformer further includes a third winding,
the rectifying circuit further includes a second rectification switching device, the second rectification switching device being coupled to the third winding and configured to be turned on and off based on a second driving signal, the rectifying circuit being further configured to rectify a signal supplied from the third winding,
the second driving circuit is further configured to generate the second driving signal;
the second driving operation further includes driving the second rectification switching device through the second driving signal, and
the signal generation circuit is configured to generate the first driving control signal, based the control signal, the first driving signal, and the second driving signal.

6. The electric power conversion apparatus according to claim 5, wherein the signal generation circuit includes:
a first input node configured to receive the control signal;
a second input node configured to receive the first driving signal;
a third input node configured to receive the second driving signal;
an output node configured to output the first driving control signal;
a first diode provided in a path coupling the first input node and the output node to each other, the first diode including an anode led to the first input node and a cathode led to the output node;
a second diode provided in a path coupling the second input node and the output node to each other, the second diode including an anode led to the second input node and a cathode led to the output node; and
a third diode provided in a path coupling the third input node and the output node to each other, the third diode including an anode led to the third input node and a cathode led to the output node.
